(19) United States
(12) Patent Application Publication
(10) Pub. No.: US 2011/0170008 A1
(43) Pub. Date: Jul. 14, 2011

(54) Chroma-key image animation tool

(76) Inventor: Terry W. Koch, Soquel, CA (US)

(21) Appl. No.: 12/657,098

(22) Filed: Jan. 13, 2010

(51) Int. Cl. H04N 9/75; G06F 3/048

(52) U.S. Cl. 348/592; 715/810; 348/E09.056; 715/727

(57) ABSTRACT

The present disclosure provides a software method and application for creating and displaying image animations based on chroma-key video and image overlay effects, including image import, image processing, and video rendering of single images, in addition to the ability of sound, music, and text insertion, for use in computerized systems. The present disclosure furthermore provides a system and method to hide the complexity of multimedia processing steps by means of an intuitive, easy-to-use graphical user interface enabling the non-professional general public to enhance photos with multimedia animations in a fast and effective way and to make them publicly available on multimedia devices, such as smart phones, and web sites on the Internet.

### BACKGROUND OF THE INVENTION

1. Technical Field

This invention relates to new systems and methods for the creation and publishing of photo animations, and more particularly, to software means and methods for publishing multimedia image animations based on chroma-key video and image overlay effects, and sound effects.

2. Background Art

The present invention utilizes chroma-key for the creation and publishing of photo animations, and more particularly, to software means and methods for publishing multimedia image animations. Chroma-key is a technique for mixing two images or frames together, in which a color or color range from one image is removed and made transparent to reveal another image behind it. This technique is also referred to as color-keying, color separation overlay, green screen, and blue screen. The technique is used for films and photos. Weather forecast broadcasts are a widely known example of its use.

This technique can also be used to animate still images. A still image is rendered into a video and overlaid by a special effect video and/or image, which are chroma-keyed. The result usually is a short duration video clip which shows the still image enhanced by special effects like e.g. a moving car, a thumping heart, an explosion. By focusing on dedicated effects, animated images typically address the attention time interval used to view a photo, yet provide the liveliness of a video. Together with sound effects, music, and overlaid text, this technique is used by professionals to raise interest and to strongly improve the expressiveness of images, which come to life.

The use of chroma-key technology in the creation of animated images based on chroma-keyed video overlay effects is traditionally hard to do, because one needs to have professional know-how of color separation techniques, image and video formats, and processing techniques to merge different media, align visual and sound effects with the underlying image, and to render a short duration video for the target device.

Digital cameras having become main stream photography devices for the general public, a number of software applications are available, which allow for basic image processing and the organized storage of digital images. The publication of images is strongly supported by so-called social web sites (e.g. Facebook, Myspace), which facilitate the provisioning of images on the Internet. While there are complex devices and software applications available for professional photographers and digital artists, a trend in the consumer market is to make the processing chain from image capturing to image publication easy, such that the general public can create and publish digital photos in a short amount of time and without the need for professional knowledge.

The same consumer trend has taken place place for personal digital videos. When published (e.g. YouTube), the length of digital videos are typically restricted to a few minutes only, in order to lower storage requirements and download times, as well as to address the limited attention span of the general public Internet user. Despite the duration limitation, the publication of videos still requires much more effort than the publication of photos and therefore is less popular than the publication of photos.

Having runtime durations in the order of seconds, animated images based on chroma-key effects fit within the two categories of still images and short duration movies and fill the demand for image liveliness, yet do not require the amount of effort needed to produce a short duration video.

Despite its capability of filling the gap between photo and video publication, no dedicated software application exists today known to applicant, which addresses the needs of the general public to easily create and publish animated images based on overlay video and image effects. First, image processing software is required to edit digital images for the required video target format. Second, chroma-keyed special effect movie clips and sound effects have to be produced or purchased from a third party, and converted to the target video format. Third, additional, advanced video editing software with chroma-key overlay and sound insertion capabilities is necessary to produce and render the video clip for the target platform. Although individual components currently exist, which address the necessary processing steps, the required knowledge is too complex and the time effort is too large to provide an easy-to-use solution for the non-professional public.

Therefore, it is very desireable to have a single software application, that provides an intuitive processing path and an easy-to-use environment, which integrates all major components, and allows for the creation and publishing of animated images by non-professional users across a wide age range and within minutes

The present invention provides such a software method and application which provides an intuitive processing path and an easy-to-use methodology, which integrates all major components, and allows for the creation and publishing of animated images by non-professional users across a wide age range and in a very short period of time.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out in the appended claims.

### BRIEF SUMMARY OF THE INVENTION

To achieve the foregoing objects, and in accordance with the purpose of the invention as embodied and broadly described herein, a software method and application is provided for creating and publishing animated images based on chroma-key video and image overlay effects, including image import, image processing, and video rendering of single images, in addition to the ability of sound, music, and text insertion. The chroma-key image animation application of the present disclosure is the only complete, easy-to-use tool for creating and publishing animated images based on chroma-key video and image overlay effects that are available on a variety of platforms, including PC, MAC, web browsers, cellular phones, smart phones, and other computing consumer devices.

The present disclosure furthermore provides a system and method to hide the complexity of the multimedia processing steps by means of an intuitive graphical user interface enabling the non-professional general public to enhance photos with multimedia animations in a fast and effective way and to make them publicly available on multimedia devices, such as smart phones, and web sites on the Internet. At the same time, more advanced processing tools are extending the basic processing steps for experienced users without affecting the intuitive system and method of creating chroma-key image animations. This allows for the non-professional public a step-by-step learning approach to more advanced processing techniques which build on the existing application and process experience.

The chroma-key image animation method and application of the present invention is designed to allow users to create animated digital images by importing a single frame image of a standard digital image format, such as e.g. jpeg, gif, png, bmp, as produced by a digital image capturing device and image application software, and including chroma-key video and image overlay effects from an integrated effect library. The application provides image and special effect editing functions, such as resizing, rotating, and cropping. The user can opt to include sound effects to be played along with the animation by simply dragging selected effects from a library of sound effects and/or by importing external audio files. An integrated text tool allows for insertion of text. The animation and each animation item can be individually timed, and the resulting video can be viewed at any point in time in an integrated playback window. When finished, the final animation can be rendered into the target publishing video format to be viewed outside the application. The complex media processing steps are accomplished by a few mouse clicks or simple drag and drop operations, and do not require any professional knowledge, however, the results obtainable are very useful for the professional as well.

In an exemplary embodiment, the video overlay animation application includes a work space window, which provides an icon bar for the direct selection of the main processing steps, a tool window for image processing and timing tools, a video effect library window, and a sound effect library window.

Using the disclosed methodology, to quickly create an animated image, the user may simply drag a standard image file into the workspace, which automatically opens an image processing window showing the movie screen overlaid by the target image. A Fit button allows for a one-click image resize operation, such that the image fits the video screen. The user can then simply drag chroma-key video effects, such as e.g. an explosion, a sticker image, and a picture frame from the video effect library window and place them onto the image. In a similar manner, sound effects can be dragged from the sound effect library window onto the image, where they appear as sound buttons in the status bar of the image processing window, which provide individual volume sliders for sound volume adjustments. A click on the text tool puts the cursor into text mode, which allows for the insertion of arbitrary image text. Each visual object can be resized by means of a size slider to adjust its appearance. A single click on a the Fade button of the icon bar allows for fade-in/fade-out framing of the video clip. Finally, the playback start time and duration can be set for each object by the timing tool. At each step along the process, the user can click on the playback button to view the current animation results in a playback window. When finished, a single click on an icon bar button allows for media formatting, image cropping, and the rendering and export of the final movie clip to the target publication format. The result is a single file, which can be viewed outside the application and on the target device or web site. The described procedure enables the creation and publication of animated images within a matter of minutes and without any professional knowledge of the complex underlying multimedia processing steps.

The chroma-key image animation methodology disclosed includes a set of options for more advanced users. For image processing, the user can zoom in and out the image processing canvas. Fill, fit, and arbitrary resize operations as well as rotation, cropping, and alignment functions allow for image selection and positioning relative to the video screen. The color of the video screen can be selected to allow for a colored background. Inserted video overlays may be rotated and stacked in arbitrary ways. Inserted text can be formatted, resized, rotated, colored, and displayed in different fonts. For video timing, the user can select the clip duration, and the start time and duration of video overlays and sound effects. The duration of fade-in and fade-out transitions can be set separately. Finally, for video rendering and export, the user can select the coding format and quality, and the video frame size. The corresponding commands are given by means of menu items and/or mouse click options and keyboard shortcuts.

Additionally, special effects may provide embedded specific features. In an exemplary embodiment, hole effects can e.g. provide the capability to allow for an arbitrary, user defined path of the hole edge, and an embedded display fade-in time interval for enhanced hole effects. For user guidance, these features are only provided when the corresponding special effect is inserted.

The methodology disclosed herein allows a user to simultaneously work on multiple image animations and to view and export multiple animations in a single video file. This allows to create and publish animated slide shows. By means of minimized image windows, the user can select, which opened image animations to include in the rendered slide show, and choose the display sequence.

The disclosed methodology also allows multiple users to collaborate together in creating animation projects. An animation work file can be saved to disk and reloaded into the workspace of the application. Users can therefore save and share their work, or include effects from different user libraries. A user can also load a work file created by another person and include this animated image into his slide show.

The methodology and application disclosed herein further allows for the inclusion of multiple visual and sound effect libraries. In addition, each effect may provide effect specific functionality, which makes the chroma-key image animation application a scalable platform for future creative art, and does not restrict it to the effect examples given herein.

The chroma-key image animation software and methodology disclosed herein allows the result of each processing step to be immediately viewed in the integrated playback window, which provides start, stop, rewind, fast forward playback commands, and allows for full screen viewing. The step-by-step method provided by the chroma-key image animation application, makes this tool simple enough for the novice PC user, while at the same time is able to satisfy the demands of advanced image animations and the need for fast publication techniques. The software method and application of the present disclosure is a intuitive creativity tool for the general public regardless of age.

### BRIEF DESCRIPTION OF THE DRAWINGS

The accompanying drawings, which are incorporated in and constitute a part of this specification, illustrate a preferred embodiment of the invention and, together with a general description given above and the detailed description of the preferred embodiment given below, serve to explain the principles of the invention.

FIG. 1 is a flow diagram of an exemplary embodiment of the chroma-key image animation methodology, according to the invention.

FIG. 2 is an exemplary screen shot of the application work space, according to the invention.

FIG. 3 is an exemplary screen shot of the image processing mode, according to the invention.

FIG. 4 is an exemplary screen shot of the video playback mode, according to the invention.

FIG. 5 is an exemplary screen shot of the video rendering mode, according to the invention.

### DETAILED DESCRIPTION OF THE INVENTION

Reference will now be made in detail to the present preferred embodiments of the invention as illustrated in the accompanying drawings. In the following description of the present invention, reference is made to the accompanying drawings which form a part thereof, and in which is shown by way of illustration, exemplary embodiments illustrating the principles of the present disclosure and how it may be practiced. It is to be understood that other embodiments may be utilized and structural changes may be made thereto without departing from the scope of the present disclosure.

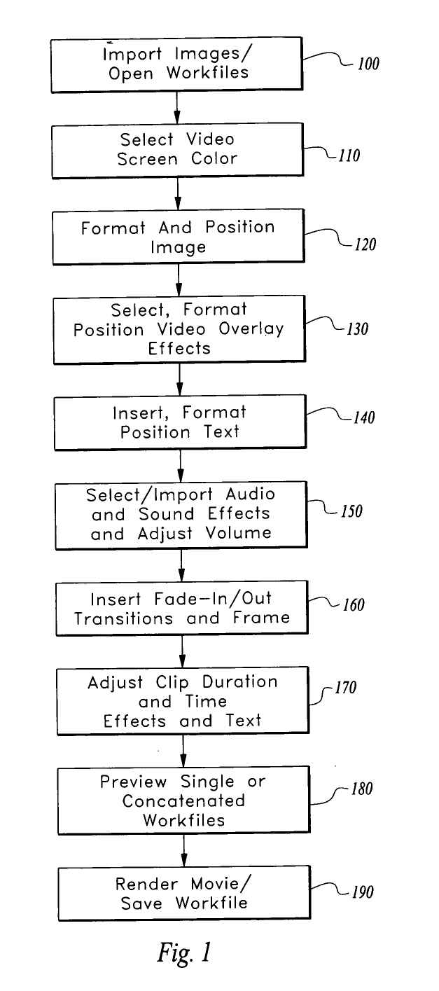

In accordance with the present invention, as seen in FIG. 1, there is provided in a preferred embodiment of the invention, a chroma-key image animation method and application designed to empower users to quickly create and publish animated images without the necessity for professional knowledge of the underlying complex multimedia processing techniques. The present disclosure is designed to provide a step-by-step method which makes this tool simple enough for the novice PC user, while at the same time is able to satisfy the demands of advanced image animations and the need for fast publication techniques. The software application of the present disclosure is an intuitive creativity tool for the general public regardless of age, computing ability, and inclination.

With reference to FIG. 1, a block flow diagram of an exemplary embodiment of the chroma-key image animation application is illustrated. The application is designed to allow users to create chroma-key image animations by processing digital images and overlay them with chroma-keyed special effect movie clips provided by an integrated effect library as well as inserting text and sound effects. The user can import digital images of standard formats, such as jpg, png, gif, bmp into an image processing window or open existing workfiles of prior work, as depicted by 100. It should be understood that there are numerous other types of digital image formats that could be used. The chroma-key image animation tool allows to color the background movie screen 110 to provide a simple colored image frame when played back. The image can be rotated, resized, aligned and cropped, as shown by 120, such that it is properly positioned with regard to the background movie screen. Chroma-keyed special effect movie clips are selected from the integrated library and dragged to the target position in the image, as depicted by 130. The clips are preferably made visible by a semi-transparent still image representing the clip, such that the user can rotate, resize, and position the clip while still viewing the underlying digital image and other visual effects. It is possible to select multiple visual effects for a single animated image, and the visual effects can be stacked on top of each other in any order. A text tool, 140, provides the capability for the user to insert arbitrary text, which can be colored and formatted using standard text format options, such as Bold, Italic, Underlined, and various font types and sizes. As depicted by 150, the user can insert multiple sound effects provided by an integrated sound effect library, and import proprietary audio, music, and sound effects provided in standard digital formats, such as mp3 and mp4. It should be understood that there are numerous other types of digital audio file formats that could be used. The chroma-key image animation tool provides the capability of adding fade-in/out transitions, as shown by 160, which are displayed at the start and end of an animated clip. An example is a simple screen to image transition for fade-in, and an image to screen transition for fade-out.

It should be understood that there are numerous other types of possible transitions that can be provided with the disclosed methodology and application. For example, the method and application further provides the capability to assign an image frame offered by a library of image frames to the screen, also shown by 160, which provides a non-transparent constant frame to the animated image and is displayed for the duration of the animation. A timing tool, depicted by 170, allows the user to set the duration of the animated movie, and to time the occurrence and duration of each visual, sound, and text effect. Each of the image processing steps can be done in any order, and be undone, and repeated where applicable. The image canvas can be zoomed at any point in time, such that detailed alignment and work can be done on selected parts of the screen.

The present method and application allow a user to simultaneously work on multiple image animations and to view and export multiple concatenated animations in a single video file, as indicated by 180. This allows a user create and publish animated slide shows. By means of minimized image windows, the user can select, which opened image animations to include in the rendered slide show, and choose the display sequence.

The processing results can be viewed at any point in time in an integrated animation playback window, as depicted by 180, which provides a start, stop, rewind, and fast forward movie functionality, and can be optionally set to full screen playback mode. As shown by 190, the animation or movie can then be exported into a number of different video and movie file formats for viewing and publication outside of the software application of the present disclosure. For example, movies may be exported as QuickTime, Windows Media Player, Real Video, AVI, or MPEG movies. It should be understood that there are numerous other types of movies and video formats that can be used.

The method and application described herein, further allows multiple users to collaborate together in creating animation projects. An animation work file can be saved to disk, as shown by 190, and reloaded into the workspace of the application, as shown by 100. Users can therefore save and share their work, or include effects from different user libraries. A user can also load a work file created by another person and include this animated image into his slide show.

The method and application disclosed herein, allows for the inclusion of multiple visual and sound effect libraries. In addition, each effect may provide effect specific functionality, which is only available when the corresponding effect is selected. In an exemplary embodiment, hole effects can e.g. provide the capability to allow for an arbitrary, user defined path of the hole edge, and an embedded display fade-in time interval for enhanced hole effects. The innovative connection of specific effect editing functionality to special effects provides intuitive user guidance, makes the chroma-key image animation application a scalable platform for future creative art, and does not restrict it to the effect examples given herein.

The present methodology and application provides a powerful chroma-key image animation tool that makes creating and publishing chroma-key image animations quick and easy for the general public or professional. In an exemplary embodiment, the chroma-key image animation tool includes an application work space provided by the main window of the application, one or more image processing windows for the image processing mode, a playback window for the playback mode, and a video rendering window for the video rendering mode.

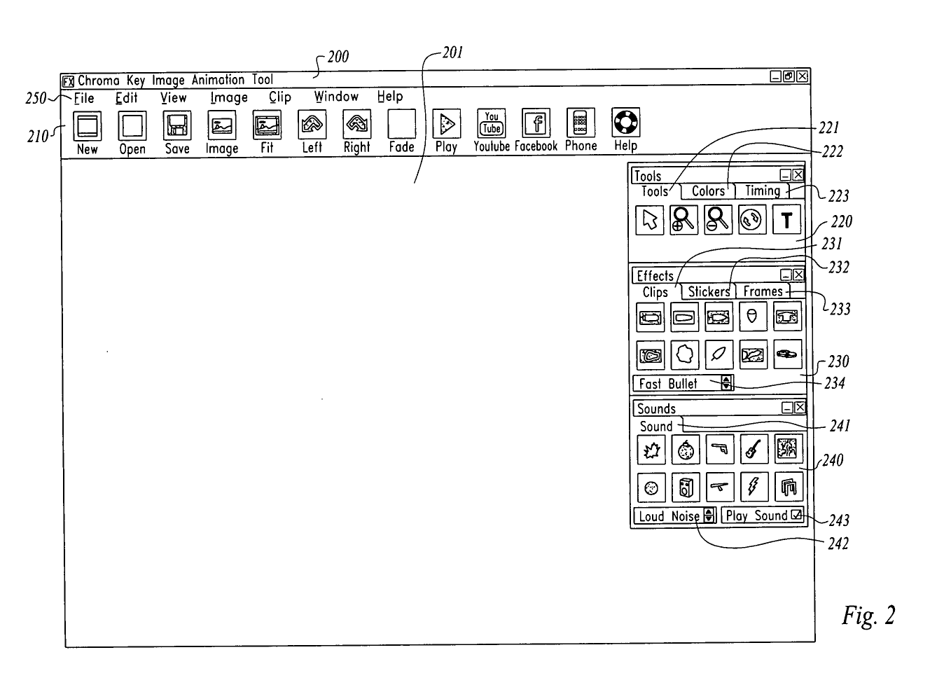

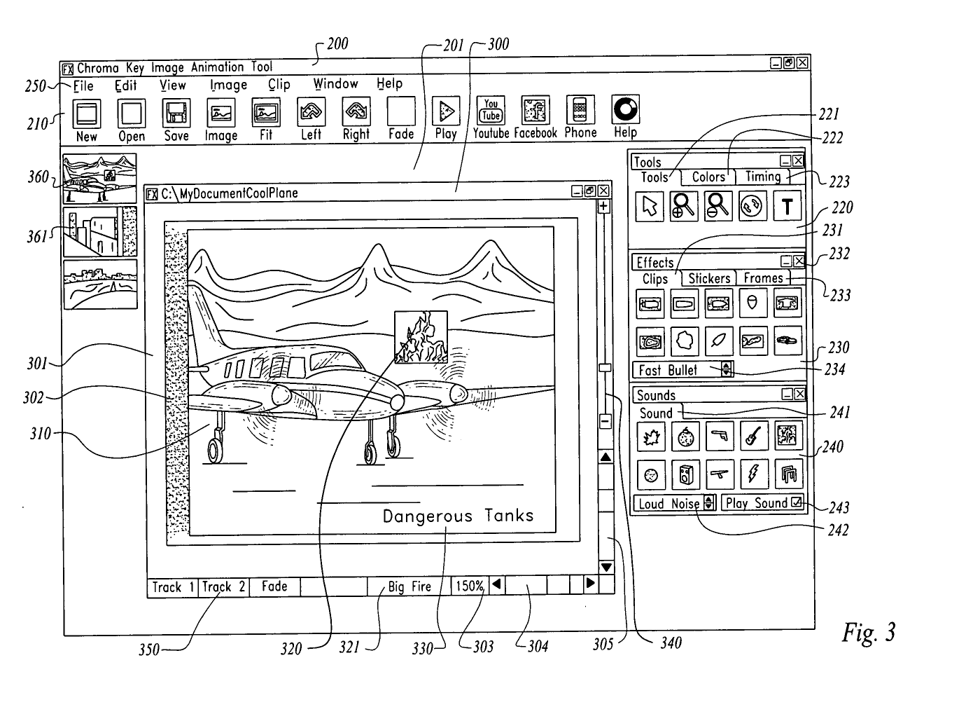

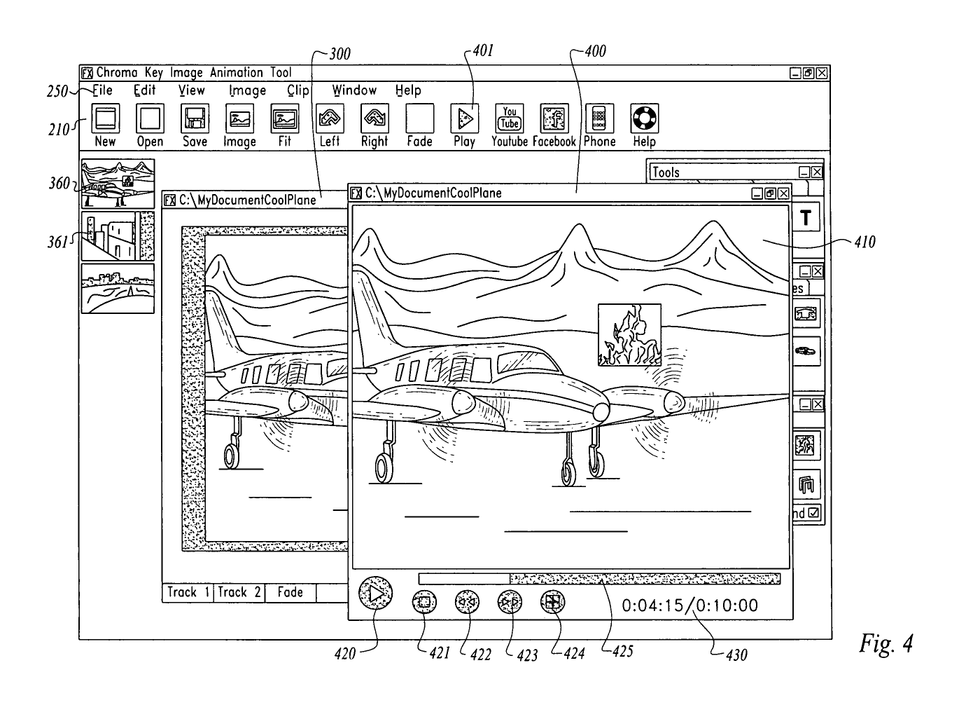

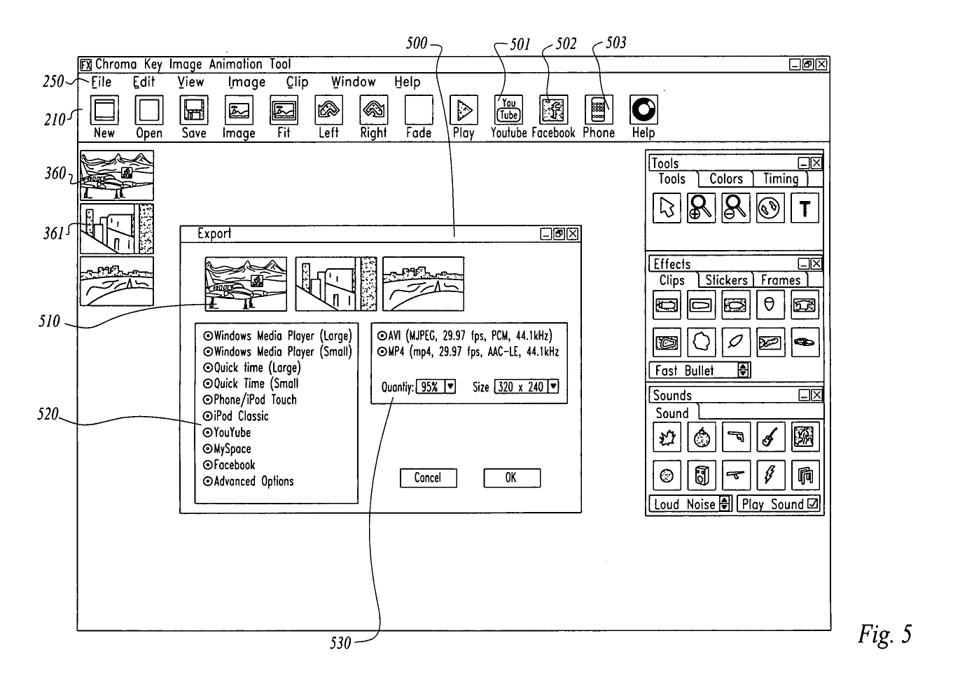

With reference now to FIG. 2, an exemplary screen shot of the application work space 200, is illustrated which comprises, an icon bar 210, an application menu 250, and tool and library windows 220, 230, 240. FIG. 3, illustrates an exemplary screen shot of the workspace containing an image processing window 300 for the image processing mode, and minimized image windows 360. FIG. 4, illustrates an exemplary screen shot of the playback window 400 for the playback mode, and FIG. 5 illustrates an exemplary screenshot of the workspace containing the video rendering window 500 for the video rendering mode.

Preferably, within the application workspace and each window, there is another functionality provided which allows the user to access a specific aspect of the main window functionality. For example, the playback window, providing an exemplary embodiment for the playback mode, allows for rewind, fast forward, stop, and a full screen mode in addition to the main functionality of video playback. In addition, the effect libraries may include numerous special effects, which provide effect specific features.

Application work space 200 is preferably provided by the main window of the application, which is available to the user for the duration of the application. The icon bar 210 illustrates an example of a collection of command icons, which give the user an intuitive and fast step-by-step guide to create and publish a chroma-key image animation. In the example shown by 210, the user can open an image processing window 300 which is providing the image processing mode and displaying the video background screen by a single click on the New icon. A click on the Image icon opens the users image folder to allow for the selection of a still user image to animate. Upon selection, the image is imported into the application, and displayed in the opened image processing window 300. For further simplification, the process of opening a new image processing window and inserting an image can be achieved in a single user step by simply dragging an image from an Operating System folder into the workspace 201.

Using the present methodology, a single click on the Fit icon of the icon bar 210 formats the still user image, such that it fits the movie screen. The user can then add video and sound effects to the opened image by simply dragging the selected special effects from the special effect library windows 230 and 240 onto the opened image. A single click on the Fade icon adds a fade-in/fade-out transition to the animated image. Each effect can be timed by user interface elements provided by the timing tab 223 of the tool window 220. At each point in time, a single click on the Play icon is sufficient to open the Playback window 400 and to play the image animated movie. A click on an target specific export icon, e.g. the YouTube, Facebook, and Smart Phone icon as shown in this exemplary embodiment, allows to render and save the movie in the target publication format.

The example of icons described herein provide graphical command shortcuts to the commands most often used, and the icon images and arrangements provide an intuitive step-by-step guide making the creation and publication of chroma-key image animations an easy process within a time span of only minutes from the animation idea to publication. It should be understood that the icon bar 210 may contain other icons, such as the file Open and Save icons shown in the exemplary screen shot of FIG. 2, for the opening and saving of processed image files, and the Left and Right icons for image and effect rotation, and the Help icon to display application instructions.

In a preferred embodiment, a special effect library window 230 for video and image effects shows available special effect content by graphical means in form of icons, which can be simply dragged into an image processing window 300 for effect insertion. For improved user guidance, the special effect movies and images are further arranged into effect categories, such as represented in the exemplary embodiment by the Clips tab 231, the Stickers tab 232, and the Frames tab 233. In the embodiment illustrated, the Clips tab represents an example for a collection of special effect chroma-keyed movie clips, which can be overlay a still user image. The Stickers tab represents an example of chroma-keyed still images with specific image functionality, such as the making of an image hole which displays the movie background at a certain playback time of the rendered movie animation. The Frames tab represents an example of chroma-keyed still images, which can overlay the user image and other visual effects to display e.g. a picture frame. A text field 234 provides a short effect description of the selected effect content. An effect tab is scrollable, such that the effect tab size does not limit the number of effects included in the application. The same arrangement is provided by the special effect window 240 for sound effects. This embodiment depicts only one sound effect tab 241, but it should be understandable that other effect tabs may be included, e.g. for noise, speech, music sound categories. A text field 242 provides a description of the selected sound, and a switch 243 allows for the playback of sound upon icon selection. A sound is inserted into an image animation by simply dragging the selected sound icon into the image processing window 300.

It is preferable that the icon bar 210 provides the basic processing steps necessary for image animation in a graphical and easy-to-use icon representation, and the special effect windows 230 and 240 provide the animation content in the same easy-to-use format. Together they provide a new system and method for the creation of chroma-key image animations, which hides the highly complex multimedia processing steps making it intuitive, quick, and easy for the general public to create chroma-key image animations with a few mouse clicks only and in a matter of minutes.

The Tools window 220 provides more advanced animation tools, which are again preferably organized in multiple tabs, such as the Tools tab 221, the Color tab 222, and the Timing tab 223 shown in the exemplary embodiment of FIG. 2. The Tools tab 221 provides icons to graphically change the cursor mode, such that the canvas can be e.g. zoomed, or selected items rotated, or text inserted into an animated image. The Color tab 222 provides graphical means, such as an RGB color slider, and other tools to change the color of selected objects, such as the movie background, text objects, and other special effect objects. The Timing tab 223 provides means of changing the default timing properties of selected objects, such as the movie duration, and start/stop times of special video, image, and sound effects. Of course, it is understood that there are numerous other tools and processing modes that can be provided by icons and other graphical elements of the tool window.

The application menu 250 provides text menus for all graphical commands and additional features for the advanced user, such as additional editing commands, view adjustment commands, image processing commands, and additional export options. The application menu therefore allows for feature scalability for the more experienced and demanding user, while keeping the basic creation steps for a chroma-key image animation easy for the general public. It should be understood that there are numerous processing and editing commands which can be added to the application menu supporting this new system and method of creating chroma-keyed image animations.

In FIG. 3, an image processing window 300, which presents an exemplary embodiment of the image processing mode and provides the processing environment for one chroma-key image animation clip. The image processing mode is either automatically entered and image processing windows are opened when a still user image is dragged into the application workspace 201 or entered by the user by means of the icon bar 210 or the application menu 250. Each image processing window provides a canvas 301, which contains the movie back screen image 302, the user image 310, and all special effect objects, such as special effect chroma-key video clips and images, sound effects, and text. Image processing windows and their multimedia content represent a processing unit, which can be saved to disk and reloaded into the application, as well as shared with other people who work on the same project. The New, Open, and Save icons of the icon bar 210 provide visual shortcuts to those essential work steps.

In the preferred embodiment, visual objects appear on the canvas of the image processing window as soon as they are dragged or inserted into the image processing window. Upon insertion, the application automatically handles the conversion of image formats, e.g. jpeg, gif, png, bmp, into the application internal format, and the correct object layering, such that all objects appear in the correct image layer for processing, playback, and export. The movie background screen 302 is the lowest layer and can be overlaid by all other objects. The user image 310 is placed on the second lowest layer, overlaid by special effect images, e.g. hole image of the Stickers tab 232 of the exemplary embodiment shown in FIG. 3. Special effect video clips 231 represent the next higher layer, followed by overlay images, e.g. from the Frames tab 233, and the text layer 330. Each layer can hold multiple objects of its kind, and the user can change the stacking order of all objects of one layer. The arrangement of visual multimedia objects into layer classes, and the flexibility to change the order of objects within each layer again provides user guidance to the general public, yet sufficient flexibility to the experienced user.

Preferably, a visual object is selected by simply clicking on its image in the image processing window. Multiple clicks select all effected visual objects in a round-robin fashion. Special effects are displayed as a single semi-transparent frame such that underlying objects and the user image are visible for processing and effect adjustment. The selection of an object is indicated by a dotted color-coded object frame as well as a text description field 321 located in the bottom bar of the image processing window.

Once selected, visual objects may be moved horizontally and vertically, resized, rotated, copied and deleted. Each of these commands again provides an easy and intuitive option for the general public, as well as more advanced options for the experienced user. Objects are stacked within their layers in the order of insertion, which is an intuitive guide for the general public. The more advanced user can change the order by selecting the up/down commands of the Image menu or by using the appropriate keyboard shortcuts. A move can be intuitively done by simply dragging an object to a new location, while the more advanced user may then continue to fine-adjust the object with the arrow keys of the keyboard. Objects can be rotated simply by multiple clicks on the rotation icons of the icon bar 210, while the more advanced user may select the rotation mode in the tool window to arbitrarily rotate the object by mouse moves or directly select a dedicated angle in the rotate command of the Image menu. In most cases, it is sufficient to insert an image and click on the fit icon of the icon bar 210 to make the image appear within the screen boundaries 302. Again, more flexible options are provided to the experienced user by the application menu, which include in the exemplary embodiment a screen fill and arbitrary image resize options, as well as multiple image alignment and cropping commands. Finally, all visual objects are resizable and the image processing window provides a graphical resize slider 340 for quick resizing, which again includes special + and − buttons for fine-tuned resize operations.

Preferably, when put into text mode by a click on the text item of the Tools tab 221, the cursor turns into a text bar indicating the capability to insert and edit text. A subsequent click inside the canvas opens a text box, which allows the user to insert text. A click on an existing text 330 opens the text for editing. A click outside an active text box returns the user to standard mode, in which he can continue to process the text label (e.g. move, resize, rotate, color) like any other visual object. The more advanced user can right click on a text box or on any selected portion of the text inside a text box, to list additional font selection and editing commands.

In a preferred embodiment, the Color tab 222 of the Tools Window 220 provides a graphical RGB slider and other means to change the color of the movie background 302, image text 330, and even special effect images when supported by a special effect image. Upon selection, the new object color is immediately displayed in the processing window allowing to fine-adjust the optical appearance. The Color tab also provides a memory capability for text objects, such that new text is automatically displayed in the color last selected.

Image processing windows 300 are resizable to allow for flexible canvas sizes, and provide horizontal 304 and vertical 305 scrollbars. The Tools window 220 provides icons for zoom-in and zoom-out modes, which allow zoom operations by simple mouse moves. A text field 303 is provided at the bottom bar of an image processing window, which displays the current zoom factor and allows for direct entries for factor changes. Keyboard shortcuts and view menu items provide additional means for the more advanced user to auto-zoom relative to the canvas, image, or screen size.

Non-visual animation objects, e.g. sound effects and the movie fade-in/out attribute, are indicated by buttons 350 at the bottom bar of the image processing window. In addition to the insertion of sound effects from the Sound tab 241 of the sound effect window 240, the application allows for the user to import external music and speech files by simply dragging the sound file onto the canvas of a processing window. Upon insertion, sound file formats, e.g. wav, pcm, mp3, mp4, are automatically converted to the internal application sound format, and the sound effect is indicated by a sound button 350. Upon a mouse click, sound effect buttons show a volume slider which allows to adjust the volume of the selected sound. More advanced users can select additional fade-in/fade-out options and sound timing attributes in the Timing tab 223 of the Tools window 220 when a sound is selected. The Timing tab also allows for the individual selection and duration settings of fade-in and fade-out options, when the fade button is selected. All objects have timing properties, which are shown by the Timing tab 223 when an object is selected. The Timing tab automatically presents the basic timing options suitable for the selected object, and again offers additional timing setting for the more advanced user.

The disclosed methodology and application allows the user to have multiple image processing windows opened at the same time, so that the user can simultaneously work on multiple chroma-key image animations. The application commands provided by the application menu 250 and the icon bar 210 as well as all content oriented operations provided by the Tools window 220 and the special effect windows 230 and 240 apply to the image processing window in focus. In addition, all visual objects can be moved by simple drag-and-drop operations between image processing windows. Each opened image processing window is also represented by a minimized window shown by 360 and 361 of FIG. 3, with a color-coded frame to indicate the window in focus 360.

Upon clicking the playback icon 401 of the application icon bar 210, the video playback mode is entered and a video playback window 400 is opened which plays back a rendered video stream 410 of the chroma-key image animation. The panel of the playback window 400 contains a play button 420, which allows to play and pause the video at any point in time. A stop button 421 stops the playback and resets the video to its starting point. A fast forward 423 and rewind 422 button provide the capability to advance and rewind the movie. The screen-mode button 424 allows to enlarge the playback screen to full monitor size. While in full-screen mode, the playback panel is hidden, and becomes visible upon detection of a mouse move. The full-screen mode is exited by clicking the screen-mode button 424. A movie slider 425 provides an optical overview of the movie playback position and allows to intuitively reposition the movie to any point in time by dragging the slider bar in the forward and backward direction. A time display 430 shows the current movie position and the total movie length.

The playback window 400 automatically detects changes made in the image processing windows and plays back the current animation configurations. This allows the user to make changes in the image processing window 300 and immediately view the resulting effects in the video stream 410. The user process of special effect alignment and timing, video viewing, and readjustment is done over and over during the creation of animated images, such that the capability of the playback window 400 to reflect immediate change of the image processing window 300 without the need for reloading the video is extremely helpful to the general public and advanced users.

The selection of multiple minimized windows 360 and 361 allows for the serial playback of multiple animations of the corresponding image processing windows. The playback sequence follows the top down arrangement of the minimized windows, and can be changed by dragging a minimized window to a different position in the top down arrangement.

The icon bar 210 preferably provides export icons to directly render a movie into a format suitable for the target application, e.g. Youtube 501, Facebook 502, Smart Phone 503 as shown in FIG. 5. The rendering process itself, i.e. the highly complex arrangement and processing of still images, video effect clips, and sounds embodied in multiple visual layers of the image processing window, is completely hidden from the user by this single-click arrangement. Upon clicking on one of the export icons, the user is asked for a filename, and the movie is rendered and saved to disk. From there it can be directly uploaded to the target application and Internet service.

The selection of multiple minimized windows 360 and 361 allows for multiple animations to be rendered into a movie in a serial manner. The rendering sequence follows the top down arrangement of the minimized windows 360 and 361, and can be changed by dragging a minimized window to a different position in the top down arrangement.

The more advanced user can open an export window 500 by selecting the Export command of the Movie menu in the exemplary embodiment. The export window provides a video bar 510, which again allows for arrangement of the rendering sequence of a multi-animation video, and the selection 520 of the rendering target application. It provides additional target options, and an Advanced Option 530, which allows the experienced user to specifically set the movie rendering format, the screen size, and the rendering quality.

In operation and use, the present invention provides a software method and application that is easy to use, reliable, and enjoyable for the user enabling the creation and publishing of animated images based on chroma-key video and image overlay effects, including image import, image processing, and video rendering of single images, in addition to the ability of sound, music, and text insertion. The chroma-key image animation application of the present disclosure is the only complete, easy-to-use tool for creating and publishing animated images based on chroma-key video and image overlay effects that are available on a variety of platforms, including PC, MAC, web browsers, cellular phones, smart phones, and other computing consumer devices.

Additional advantages and modification will readily occur to those skilled in the art. The invention in its broader aspects is, therefore, not limited to the specific details, representative apparatus and illustrative examples shown and described. Accordingly, departures from such details may be made without departing from the spirit or scope of the applicant's general inventive concept.

What is claimed is:

1. A method for creating and displaying a chroma-key image animation using a computer, comprising:
importing image and data libraries in a computer readable medium, said image and data libraries including data sets including, visual, audio, and special effects;
selecting chroma-key effects, images, videos and other data sets from a content library into processing widows,
transforming said selected chroma-key effects, images, videos and other data sets images in said computer; and
displaying the transformed images on a computer display.

2. The method for creating and displaying a chroma-key image animation using a computer of claim 1, further including:
providing a user interface comprising a user-guiding icon bar, windows for iconized scalable effect libraries and animation editing tools, including image processing windows;
importing still user images from an external storage media into separate processing windows;
utilizing chroma-key effect videos and images from a content library into a processing window;
importing audio files from external storage media and a scalable content library into processing windows;
providing the ability to insert text into processing windows;
providing a plurality of editing functions for visual objects in processing windows;
providing the ability to auto-arrange visual objects into image layers suitable for chroma-key image animations;
providing the ability to set object specific attributes including start time, stop time, fade-in, fade-out, and other video transition effects;
providing the object specific ability to extend object properties and animation features;
providing the ability to render all objects into a chroma-key image animation movie, comprising the synchronized appearance of all visual objects, audio effects, and other movie properties;
providing the ability to playback rendered image animations at any point in time from the currently opened processing windows;
providing the ability to export the rendered image animation into a movie file suitable for external viewing, and
saving the processing windows together with their edited content information to external storage media and reading such processing windows from the external storage media.

3. The method for creating and displaying a chroma-key image animation using a computer of claim 2, wherein said icon bar provides command icons for a step-by step intuitive user method to create user chroma-key images.

4. The method for creating and displaying a chroma-key image animation using a computer of claim 2, wherein said window for iconized scalable effect libraries present a library content in the form of icons, which are organized in separate, functionality and content specific scrollable tabs, providing the ability for drag-and-drop operations to insert said library content into image animations.

5. The method for creating and displaying a chroma-key image animation using a computer of claim 2, wherein a window for animation editing tools present editing tools and object properties in icon form and other graphical interface elements, organized in separate, functionality and content specific, scrollable tabs, providing the ability and guidance to quickly edit animation objects and change their properties.

6. The method for creating and displaying a chroma-key image animation using a computer of claim 2, wherein image processing windows provide the capability to present all animation objects included in a single image animation, wherein multiple such image processing windows may exist simultaneously displaying the same or different animation content.

7. The method for creating and displaying a chroma-key image animation using a computer of claim 2, wherein said import of still user images may be accomplished by dragging an image file from the application external computer environment in the application work space, and the image file is a jpeg, png, gif, or bmp file, or a file containing any other image format.

8. The method for creating and displaying a chroma-key image animation using a computer of claim 2, wherein said chroma-keyed video and image effects are represented in processing windows by semi-transparent images allowing the ability to view their position and appearance with respect to other objects position above or beneath the video and image effect.

9. The method for creating and displaying a chroma-key image animation using a computer of claim 2, wherein the import of said external audio file is accomplished by dragging an audio file from the application external computer environment into a processing window, and the audio file is a wav, pcm, mp3, m4a file or a file containing any other audio format.

10. The method for creating and displaying a chroma-key image animation using a computer of claim 2, wherein said auto-arrangement of visual animation objects into image layers suitable for chroma-key animations is such that said movie screen layer represents a lowest layer, the still user image a second lowest layer, one or more effect image layers the next higher layers, effect movies a next higher layer, followed by another set of one or more effect image layer content within a frame edge, and the frame image edge color being changeable by the user.

11. The method for creating and displaying a chroma-key image animation using a computer of claim 2, wherein animation objects can provide object specific properties and extend animation features, in particular that an animation hole image can display the movie screen within its edge at a specific playback time and for a specific duration, and that the hole image edge color is changeable by the user, so that an animation frame image can display lower layer content within the frame edge, and that the frame image edge color is changeable by the user.

12. The method for creating and displaying a chroma-key image animation using a computer of claim 2, wherein said user guided icon bar provides a playback icon, which permits an opening of a playback window, render said chroma-key animation, and to play back a movie at any point in time by a single mouse click.

13. The method for creating and displaying a chroma-key image animation using a computer of claim 2, wherein said user guided icon bar provides target specific export icons, which allow the user to render said chroma-key animation and to export said movie to a target format at any point in time by a single mouse click, where the target format is a wmv, avi, mp4, or any other movie file format suitable for movie playback by external applications.

14. The method for creating and displaying a chroma-key image animation using a computer of claim 2, wherein multiple image animations are played back in a single movie in a serial manner, when multiple image processing windows are selected prior to playback, and where the sequence of play can be selected by arrangement of minimized versions of the processing windows.

15. The method for creating and displaying a chroma-key image animation using a computer of claim 2, wherein multiple image animations are exported back to a single movie in a serial manner, when multiple image processing windows are selected prior to export, and where the sequence of playback can be selected by arrangement of minimized versions of the processing windows.

16. A method for creating and displaying image and special effects animations using chroma-key image animations, comprising:
establishing data libraries in a computer readable medium; said data libraries including a plurality of image, sound, and special effect data sets;
selecting a data set from said data libraries, said data set being selected from said plurality of image, sound, and special effects data sets;
positioning said selected data set in a computer processor and transforming said selected data by combining one or more of said data sets; and
displaying the transformed data sets on a computer display in communication with said computer processor.

17. The method for creating image and special effects animations using chroma-key image animations of claim 16, wherein an image processing mode having the ability to display a movie background screen, an imported still image, and imported chroma-key effect movies and images, as well as text and other visual objects are utilized, including the further ability to make properties of such visual objects available to a user for editing by means of graphical interface objects, a computer mouse, a keyboard;
a video playback mode configured to render a movie from all objects of a processing window and to play back a resulting movie in a playback window; and
a video rendering mode to render a movie from all objects of a processing window, and to export a resulting movie to a movie format suitable for playback in external applications.

18. The method for creating image and special effects animations using chroma-key image animations of claim 17, wherein said image processing mode allows the user to move, resize, rotate, crop, align, copy and delete visual objects, as well as to change the object order within an object layer.

19. The method for creating image and special effects animations using chroma-key image animations of claim 17, wherein said image processing mode allows the user to insert, edit, and format text.

20. The method for creating image and special effects animations using chroma-key image animations of claim of claim 17. wherein said processing mode includes the ability to select objects by mouse clicks in a round-robin manner, and to indicate an object selection by color-coded object frames

21. The method for creating image and special effects animations using chroma-key image animations of claim 17, wherein said processing mode includes the ability to zoom and scroll said processing canvas in order to adjust the display of the visual objects.

22. The method for creating image and special effects animations using chroma-key image animations of claim 17, wherein said processing mode displays non-visual animation objects by visible graphical user interface buttons.

23. The method for creating image and special effects animations using chroma-key image animations of claim 17, wherein said processing mode is configured such that properties of selected objects are made accessible and editable in a separate window.

24. The method for creating image and special effects animations using chroma-key image animations of claim 17, wherein said processing mode provides the capability to save a work file to computer storage to store the current object configuration, and to load a named workfile from computer storage to restore the object configuration.

25. The method for creating image and special effects animations using chroma-key image animations of claim 17, wherein said processing mode provides the ability to create and edit multiple chroma-key image animations at the same time by displaying separate processing windows for each animation.

26. The method for creating image and special effects animations using chroma-key image animations of claim 17, wherein said playback mode is configured such that it renders and plays back a current animation configuration of said processing window in focus or of multiple selected processing windows.

27. The method for creating image and special effects animations using chroma-key image animations of claim 17, wherein said video rendering mode provides the ability to render a current animation configuration of said processing window in focus or of multiple selected processing windows
